(19) United States
(12) Patent Application Publication
(10) Pub. No.: US 2009/0036625 A1
(43) Pub. Date: Feb. 5, 2009

(54) Amphiphilic Polymer, Method for Forming the Same and Application thereof

(75) Inventors: Walter Hong-Shong Chang, Tao-Yuan (TW); Cheng-An J. Lin, Tao-Yuan (TW); Jimmy Kuan-Jung Li, Tao-Yuan (TW); Martin Oheim, Paris (FR); Aleksey Yakovlev, Paris (FR); Anne Feltz, Orsay (FR); Camilla Luccardini, Paris (FR); Maria Teresa Fernandez-Arguelles, Oviedo (ES); Ralph A. Sperling, Eltville am Rhein (DE); Wolfgang J. Parak, Marburg (DE)

Correspondence Address: WPAT, PC, 7225 BEVERLY ST., ANNANDALE, VA, 22003, US

(73) Assignee: CHUNG YUAN CHRISTIAN UNIVERSITY, Tao-Yuan (TW)

(21) Appl. No.: 11/832,105

(22) Filed: Aug. 1, 2007

(51) Int. Cl. C08F 222/04; C08F 222/06

(52) U.S. Cl. 526/272; 526/271

(57) ABSTRACT

The present invention discloses an amphiphilic polymer, comprising a polymer backbone, at least one hydrophobic side chain, and at least one hydrophilic side chain wherein one end of the hydrophobic side chain is bound to the polymer backbone and one end of the hydrophilic side chain is bound to the polymer backbone. The polymer backbone is derived from a homopolymer or copolymer of an anhydride. In addition, the present invention discloses a water-soluble polymer micell having the above described amphiphilic polymer and forming method and applications thereof.

### BACKGROUND OF THE INVENTION

1. Field of the Invention

The present invention is generally related to an amphiphilic polymer, and more particularly to an amphiphilic polymer derived from a homopolymer or copolymer of an anhydride and forming method and applications thereof.

2. Description of the Prior Art

It has been an important research subject for industry and researchers to have a nanostructure surface possess specific active groups. By adjusting the material, dimension, and shape of nanoparticles, the nanoparticles can have a variety of properties, such as fluorescence, phosphorescence, optical absorption, magnetic moment, etc. These properties can be detected by other technology. Thus, nanoparticles can be applied in various areas, such as semiconductor optical devices, catalyst, energy storage materials, and biomedical materials. Especially, in life sciences, the active groups bound to the surface of such nanoparticles will specifically be bound to their corresponding receptors. Such constructs, as for instance gold or semiconductor nanoparticles decorated with oligonucleotides, streptavidin or antibodies, have been successfully used in life sciences to trace the position of single proteins within the membrane of living cells, and to visualize the structure of artificially created nanostructures.

The most effective method for having a nanostructure surface possess specific active groups is to have the nanostructure surface coated by an amphiphilic polymer shell so as to introduce various specific active groups on the nanostructure surface and to have such composite nanostructure structure suspended in aqueous solution. By the coating process, nanostructures of different materials, such as fluorescent or magnetic ones, having an identical chemical surface property can be formed. In addition, the coated amphiphilic polymer shell is uniform and thereby there is no dimension variation problem for coated nanoparticles. However, the commercial amphiphilic polymer shell is very expansive and cannot satisfy the requirements of various specific groups. Besides, its quality is also unstable. Therefore, a novel amphiphilic polymer is needed to extend the application areas of nanostructures of various materials. Selection of various specific groups and simple processes are provided and thus the manufacturing cost can be reduced.

### SUMMARY OF THE INVENTION

In light of the above background, in order to fulfill the requirements of the industry, the present invention provides an amphiphilic polymer derived from a homopolymer or copolymer of an anhydride and forming method and applications thereof.

One object of the present invention is to provide a water-soluble polymer micell, comprising: a polymer backbone, at least one hydrophobic side chain, and at least one hydrophilic side chain. One end of the hydrophobic side chain is bound to the polymer backbone. In addition, the hydrophobic side chain attracts to each other and aggregates inwardly so as to form a core of the polymer micelle. Besides, one end of the hydrophilic side chain is bound to the polymer backbone. The hydrophilic side chain forms a shell of the polymer micell so as to disperse and stabilize the polymer micell in aqueous solution

Another object of the present invention is to introduce a specific group to the exterior surface of a polymer micell, such as specific chemical functional group, fluorescent molecule, magnetic molecule, biological molecule or any combination of the above.

Another object of the present invention is to form a nano/sub-nano structure having single functionality or multiple functionalities by introducing the specific group to the nano/sub-nano structure via a polymer shell. Therefore, this present invention does have the economic advantages for industrial applications.

Accordingly, the present invention discloses an amphiphilic polymer, comprising a polymer backbone, at least one hydrophobic side chain, and at least one hydrophilic side chain wherein one end of the hydrophobic side chain is bound to the polymer backbone and one end of the hydrophilic side chain is bound to the polymer backbone. The polymer backbone is derived from a homopolymer or copolymer of an anhydride. In addition, the present invention discloses a water-soluble polymer micell having the above described amphiphilic polymer and forming method and applications thereof.

### BRIEF DESCRIPTION OF THE DRAWINGS

FIG. 1A shows a schematic structural diagram of a hydrophobic molecule according to the first embodiment of the present invention;

FIG. 1B shows a schematic structural diagram of a hydrophobic molecule according to the first embodiment of the present invention;

FIG. 2A shows a schematic structural diagram of a hydrophilic molecule according to the first embodiment of the present invention;

FIG. 2B shows a schematic structural diagram of a hydrophilic molecule according to the first embodiment of the present invention;

FIG. 2C shows a schematic structural diagram of a hydrophilic molecule according to the first embodiment of the present invention;

FIG. 3 shows a schematic structural diagram of a water-soluble polymer micell with a specific group according to the second embodiment of the present invention; and

FIG. 4 shows a schematic structural diagram of a composite with a nano/sub-nano core and a polymer shell according to the second embodiment of the present invention.

### DESCRIPTION OF THE PREFERRED EMBODIMENTS

What is probed into the invention is an amphiphilic polymer and forming method and application thereof. Detail descriptions of the processes and compositions will be provided in the following in order to make the invention thoroughly understood. Obviously, the application of the invention is not confined to specific details familiar to those who are skilled in the art. On the other hand, the common processes and compositions that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

### Definition

The term “nano/sub-nano structure” means nanostructure or sub-nanostructure. The dimension of the nanostructure is about 1˜100 nm while that of the sub-nanostructure is less than 1 nm. They can be made of organic, inorganic or metal material. Preferably, they can be made of metal and metal oxide or semiconductor nanocrystals. “Semiconductor nanocrystals” herein is used synonymously with the term colloidal “quantum dot” as commonly understood, that are composed of a semiconducting material, such as: IIA-VIA semiconductors, IIIA-VA semiconductors, IVA-IVA semiconductors, and IVA-VIA semiconductors, and are made in such a way as to crystallize in exceedingly small sizes, e.g. from 2-20 nm in diameter. The semiconductor nanocrystals used herein are colloidal, which refers to the fact that the semiconductor nanocrystals are dispersed within a continuous medium in a manner that prevents them from being filtered easily or settled rapidly. Preferably, the semiconductor nanocrystals used herein luminance upon excitation by electric power or a light source. On the other hand, the nano/sub-nano structure according to the present invention can be further modified by introducing a specific group to the exterior polymer shell, such as specific chemical functional group, fluorescent molecule, magnetic molecule, biological molecule or any combination of the above.

The “biological molecule” in the present invention comprises monoclonal antibodies, polyclonal antibodies, nucleic acids including monomeric and oligomeric types, proteins, enzymes, lipids, polysaccharides, sugars, peptides, polypeptides, and bioligands (e.g. biotin).

The “fluorescent molecule” in the present invention comprises organic dyes, fluorescent proteins, quantum dots, Lanthanide chelates.

The “magnet molecule” in the present invention comprises contrast agents, e.g. Gadolinium, paramagnetic iron oxides or superparamagnetic iron oxides.

The “drug” in the present invention comprises nuclear medical drugs, interferon, cardiovascular drugs, and anti-cancer drugs.

In a first embodiment of the present invention, an amphiphilic polymer is disclosed. The amphiphilic polymer comprises a polymer backbone, at least one hydrophobic side chain, and at least one hydrophilic side chain. One end of the hydrophobic side chain is bound to the polymer backbone and one end of the hydrophilic side chain is bound to the polymer backbone. The polymer backbone is derived from a homopolymer or copolymer of an anhydride, whose molecular weight is more than or equal to 1000. The common homopolymer or copolymer of the anhydride comprises one selected from a group consisting of the following: poly(maleic anhydride), poly(isobutylene-alt-maleic andydride), Poly(maleic anhydride-alt-1-octadecene), Poly(maleic anhydride-alt-1-tetradecene), Poly(ethylene-alt-maleic anhydride), Polyethylene-graft-maleic anhydride, Polyisoprene-graft-maleic anhydride, Polypropylene-graft-maleic anhydride, Poly(styrene-co-maleic anhydride), Poly(methyl vinyl ether-alt-maleic anhydride).

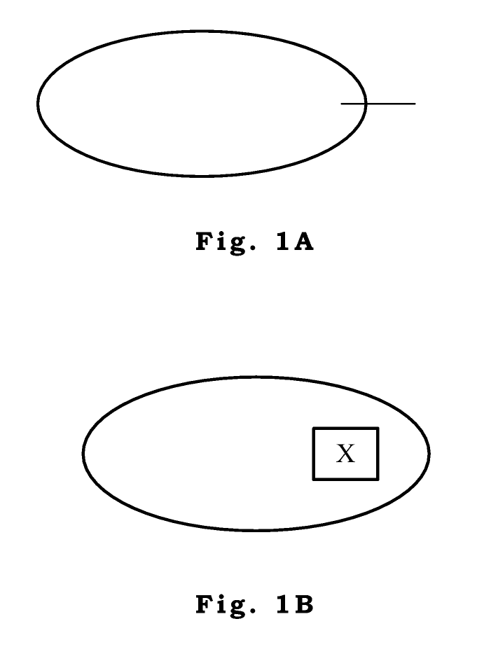

In a preferred example of this embodiment, the hydrophobic side chain is formed by hydration of a hydrophobic molecule and the homopolymer or copolymer of the anhydride. The hydrophobic molecule comprises a first group to have hydration reaction with the anhydride and also to form carboxyl group bound to amide group. The first group comprises one selected from a group consisting of the following: amino group, hydroxyl group, and thiol group. In addition, two preferred constructs of the hydrophobic molecule are illustrated: (1) as shown in FIG. 1A, the hydrophobic molecule comprises a spacer bound with the first group X; (2) as shown in FIG. 1B, the hydrophobic molecule comprises a spacer having the first group X therein. As the hydrophobic molecule belongs to the first case, the spacer comprises oligomers or polymers, containing more than or equal to four carbons. It is formed by polymerization of the compound selected from a group consisting of the following: epoxides, cyclic acetals, lactams, N-carboxy-α-amino acid anhydrides, lactones, cyclic amines, styrenes (e.g. m-methylstyrenes, p-methylstyrenes, p-t-butylstyrenes, p-bromostyrenes, p-chlorostyrenes, p-fluorostyrenes, and p-trifluoro-methylstyrenes), alkyl acrylates (e.g. methyl acrylates, ethyl acrylates, n-butyl acrylates, and t-butyl acrylates), alkyl methacrylates (e.g. methyl methacrylates, ethyl methacrylates, and n-butyl methacrylates), acrylonitriles, 4-vinyl pyridines, vinyl chloride, RuCl₂(PPh3)₃, trispyrazolyl borate-based complex, Ru-carbene complex, phosphine-based Ni(II) bromide complex, alkylphosphine complex, FeCl₂(PPh3)₂, imidazolydene, n-Bu3N, n-Bu3P, 4,4′-bis(5-nonyl)-2,2′-bipyridine, bidentate (e.g. bipyridines, pyridinimines, and diamines), tridentate, quadridentate, hexadentate, dienes (e.g. isoprene) and their derivatives.

The common oligomers or polymers comprise one selected from a group consisting of the following or any combination of the following: alkanes, aromatics, alkane-aromatics, polyoxypropylene (PPO), polyoxybutylene (PBO), polylactic acid (PLA), polylactic acid-polyglycolic acid copolymer, polycaprolactone, drugs and their derivatives or copolymers. On the other hand, as the hydrophobic molecule belongs to the second case, the spacer comprises one selected from a group consisting of the following: fluorescent molecule, magnetic molecule, and drug.

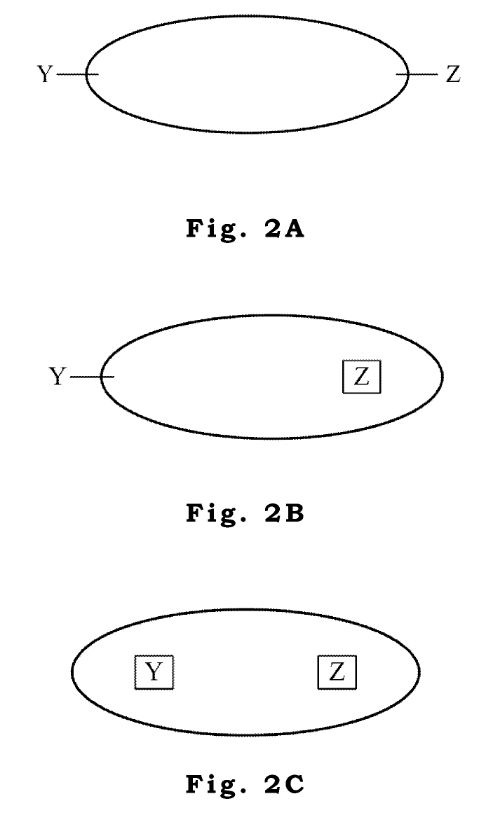

In a better example of this embodiment, the hydrophilic side chain is formed by hydration of a hydrophilic molecule and the homopolymer or copolymer of the anhydride. The hydrophilic molecule comprises a second group to have hydration reaction with the anhydride. The second group comprises one selected from a group consisting of the following: amino group, hydroxyl group, and thiol group. In addition, three preferred constructs of the hydrophilic molecule are illustrated: (1) as shown in FIG. 2A, the hydrophilic molecule comprises a spacer bound with the second group Y and the specific group Z; (2) as shown in FIG. 2B, the hydrophilic molecule comprises a spacer bound with the second group Y and having the specific group Z therein; and (3) as shown in FIG. 2C, the hydrophilic molecule comprises a spacer having the second group Y and the specific group Z therein. As the hydrophilic molecule belongs to the first case, the spacer comprises oligomers or polymers, which comprise one selected from a group consisting of the following or any combination of the following: polyols, polyethers polyols, polyester polyols, polycarbonate polyols, polycaprolactone polyols, polyacrylate polyols, and their copolymers. The polyethers polyols comprise PEG (polyethylene glycol), PPG (polypropylene glycol), and PTMEG (polytetramethylene glycol). The polyester polyols comprise PCL (polycaprolactone), PBA (polybutanediol-co-adipate glycol), and PHA (polyhexanediol-co-adipate glycol). Furthermore, the specific group comprises one selected from a group consisting of the following: amino group, thiol group, fluorescent molecule, magnetic molecule, biological molecule, and drug. On the other hand, as the hydrophilic molecule belongs to the second or third case, the spacer comprises one selected from a group consisting of the following: fluorescent molecule, magnetic molecule, and biological molecule.

For example, the hydrophilic molecule can be biotin hydrazide, mPEG-amine, amine-PEG-amine, cystamine, fluorescein-amine, ATTO-amine, amino-galactose, and biotin-PEG-amine where PEG represents polymers or oligomers.

The amphiphilic polymer according to the present invention can be utilized in hydrophilic surface modification. At first, a substrate with a hydrophobic surface is provided, such as polytetrafluoroethylene (PTFE), polyesters, polyenes, polydimethylsiloxane (also called silicones), etc. Next, the amphiphilic polymer is dispersed in an anhydrous solvent to form a modification solution. Then, a contact process is carried out to have the modification solution and the substrate contact with each other and thus to have the hydrophobic side chain of the amphiphilic polymer attract and wrap the substrate to form a modified layer on the surface of the substrate so as to introduce the hydrophilic side chain on the surface of the substrate. The contact process may comprise a heating process and the temperature range of the heating process is more than or equal to 40° C. Therefore, sufficient energy is provided to promote the motion of polymer chains so as to enhance the coating effect. The bonding between the hydrophobic side chain and the substrate can be either physical bonding or chemical bonding. The bonding comprises one selected from a group consisting of the following or any combination of the following: covalent bond, affinity, and Van der Waals force.

After the modified layer is formed, a solvent removal process is carried out to obtain a solid-state modified layer. Furthermore, a crosslinking process by a crosslinking agent is carried out to the modified layer. Preferably, the crosslinking agent is used to react with the residual anhydride group in the modified layer.

On the other hand, the amphiphilic polymer according to the present invention can be utilized in hydrophobic surface modification. At first, a substrate with a hydrophilic surface is provided, such as silicon dioxide, hydroxyethyl cellulose, etc. Next, the amphiphilic polymer is dispersed in an anhydrous solvent to form a modification solution. Then, a contact process is carried out to have the modification solution and the substrate contact with each other and thus to have the hydrophilic side chain of the amphiphilic polymer attract and wrap the substrate to form a modified layer on the surface of the substrate so as to introduce the hydrophobic side chain on the surface of the substrate. The contact process may comprise a heating process and the temperature range of the heating process is more than or equal to 40° C. Therefore, sufficient energy is provided to promote the motion of polymer chains so as to enhance the coating effect. The bonding between the hydrophilic side chain and the substrate can be either physical bonding or chemical bonding. The bonding comprises one selected from a group consisting of the following or any combination of the following: covalent bond, coordinate bond, ionic bond, hydrogen bond, affinity, and Van der Waals force.

After the modified layer is formed, a solvent removal process is carried out to obtain a solid-state modified layer. Furthermore, a crosslinking process by a crosslinking agent is carried out to the modified layer. Preferably, the crosslinking agent is used to react with the residual anhydride group in the modified layer.

In a second embodiment of the present invention, a water-soluble polymer micell is disclosed. The water-soluble polymer micell comprises a polymer backbone, at least one hydrophobic side chain, and at least one hydrophilic side chain. The polymer backbone is derived from a homopolymer or copolymer of an anhydride, which is selected in the same manner as that in the first embodiment. One end of the hydrophobic side chain is bound to the polymer backbone. The hydrophobic side chain attracts to each other and aggregates inwardly so as to form a core of the polymer micelle. Moreover, one end of the hydrophilic side chain is bound to the polymer backbone. The hydrophilic side chain forms a shell of the polymer micell so as to disperse and stabilize the polymer micell in aqueous solution.

The hydrophobic side chain is formed by hydration of a hydrophobic molecule and the homopolymer or copolymer of the anhydride. The hydrophobic molecule comprises a first group to have hydration reaction with the anhydride. The first group and the hydrophobic molecule are selected in the same manner as those in the first embodiment. On the other hand, the hydrophilic side chain is formed by hydration of a hydrophilic molecule and the homopolymer or copolymer of the anhydride. The hydrophilic molecule comprises a second group to have hydration reaction with the anhydride. The second group and the hydrophilic molecule are selected in the same manner as those in the first embodiment.

### EXAMPLE 1

### SYNTHESIS OF AMPHIPHILIC POLYMER INTERMEDIATE

An amphiphilic polymer intermediate is formed by grafting a hydrophobic primary alkyl amine to the backbone of a hydrophilic poly(maleic anhydride). The grafting reaction is spontaneous and the primary alkyl amine and anhydride react spontaneously to form amide group as well as carboxyl group. In this example, 3.084 g (20 mmol of monomer) poly(isobutylene-alt-maleic anhydride (Mw˜6,000; Sigma #531278) is placed in a round-bottomed flask. It is assumed that all of the anhydrides are under unreacted state, defined as 100% of anhydride equivalent. Next, dodecylamine (98%; Sigma #D22,220-8) is dissolved in 100 ml of tetrahydrofuran anhydrous (THF, ≧99.9%, Aldrich #186562). 15 mmol of the solution (amino group equivalent is 75% of the anhydride equivalent) is taken to be violently mixed with the anhydride polymer for a few seconds to form a mist mixture. Then, the mixture is processed with supersonic oscillation for a few seconds and then placed at 60° C. and stirred continuously. After 5˜10 mins, the spontaneous reaction between amino group and anhydride is basically complete. The reaction solution turns to transparent. In order to further enhance extent of the reaction, the rotary evaporator (Laborota 400, Heidolph) is used to concentrate the volume of the reaction solution to ⅕ (pressure range: 200-120 mbar, operating period: 3 hrs). After the concentration process is complete, the concentrate is placed at 60° C. and stirred continuously overnight. The solvent is then slowly evaporated until a complete-dried amphiphilic polymer intermediate is obtained (pale yellow solids). Finally, the amphiphilic polymer intermediate is further dissolved in anhydrous chloroform to have a total volume of 25 ml and to adjust the concentration of the amphiphilic polymer intermediate to be 0.8M. In this example, the amphiphilic polymer intermediate provided comprises 25% unreacted anhydride equilvalent, which can be used in the following coating process or in the reaction with other groups.

### EXAMPLE 2 SYNTHESIS OF ETHYLENE GLYCOL GRAFTING AMPHIPHILIC POLYMER

Proper amount of diethylene glycolamine (Aldrich A54059, hereinafter abbreviated as DEGA) is dissolved in chloroform and the concentration is adjusted to be 0.8M. 1.5 ml of DEGA (0.8M) is added to 6 ml of the amphiphilic polymer intermediate (0.8M, defined as 100% of anhydride equivalent and provided by Example 1) and the solution is violently stirred. The added DEGA equivalent is about 25% of anhydride equivalent. The reactant is concentrated by a vacuum evaporator. Then, the solvent is completely evaporated to obtain the product, ethylene glycol grafting amphiphilic polymer. Finally, the product is further dissolved in anhydrous chloroform and the total volume is adjusted to be 12 ml so as to have the concentration of the product solution be 0.4M. Besides, in order to remove the residual DEGA, the product solution is placed at a room temperature and stirred overnight.

### EXAMPLE 3 SYNTHESIS OF FLUORESCENT DYE GRAFTING AMPHIPHILIC POLYMER

In order to attach fluorescent dye with an amino group (hereinafter referred to as “amino dye”) on the amphiphilic polymer intermediate, 1 mg of the amino dye (ATTO 700-amine, from ATTO-TEC GmbH) is dissolved in anhydrous chloroform. The concentration of the amino dye is detected by measuring the optical density at 700 nm. The extinction coefficient of ATTO 700-amine provided by the supplier is 120000 M⁻¹cm⁻¹. At a room temperature, 20 μl of the amphiphilic polymer intermediate (0.8M, defined as 100% of anhydride equivalent and provided by Example 1) and 20 ml of the amino dye (8 μM, its equivalent is about 1% of anhydride equivalent.) are mixed together and violently stirred. The reaction continues and the solution is stirred overnight. The obtained reactant is processed by a vacuum evaporator. Then, the solvent is completely evaporated to obtain the solid powder product. Finally, the product is further dissolved in anhydrous chloroform and the total volume is adjusted to be 20 ml so as to have the concentration of the product solution be 0.8 mM.

### EXAMPLE 4 SYNTHESIS OF SACCHARIDE GRAFTING AMPHIPHILIC POLYMER

At first, 43.4 mg of aminophenyl galactopyranoside (Sigma A9545) is dissolved in 20 ml of anhydrous THF and then the solution is treated with supersonic oscillation to obtain a saccharide solution with a concentration of 8 mM. Anhydrous chloroform is used to dilute the saccharide solution to 10 times the volume so as to have the concentration of the saccharide solution be 0.8 mM. Then, at a room temperature, 1 ml of the amphiphilic polymer intermediate (0.8M, defined as 100% of anhydride equivalent and provided by Example 1) and 20 ml of the saccharide solution (0.8 mM, its equivalent is about 2% of anhydride equivalent.) are mixed together and violently stirred. The reaction continues and the solution is stirred overnight. The obtained reactant is processed by a vacuum evaporator. Then, the solvent is completely evaporated to obtain the solid powder product. Finally, the product is further dissolved in anhydrous chloroform and the total volume is adjusted to be 20 ml so as to have the concentration of the product solution be 40 mM.

### EXAMPLE 5 SYNTHESIS OF BIOTIN GRAFTING AMPHIPHILIC POLYMER

At first, 10 mg of biotin-poly(ethyleneglycol)amine (Average Mw=720 Da, Sigma B9931) is dissolved in 0.868 ml of anhydrous THF to obtain a biotin-PEG solution with a concentration of 1.6 mM. Anhydrous chloroform is used to dilute the biotin-PEG solution to 2 times the volume so as to have the concentration of the biotin-PEG solution be 0.8 mM. Then, at a room temperature, 0.25 ml of the amphiphilic polymer intermediate (0.8M, defined as 100% of anhydride equivalent and provided by Example 1) and 5 ml of the biotin-PEG solution (0.8 mM, its equivalent is about 2% of anhydride equivalent.) are mixed together and violently stirred. The reaction continues and the solution is stirred overnight. The obtained reactant is processed by a vacuum evaporator. Then, the solvent is completely evaporated to obtain the solid powder product. Finally, the product is further dissolved in anhydrous chloroform and the total volume is adjusted to be 5 ml so as to have the concentration of the product solution be 40 mM.

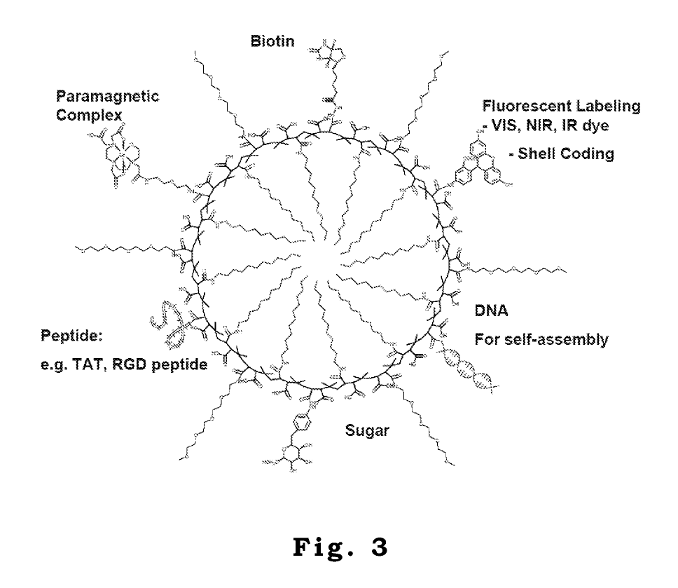

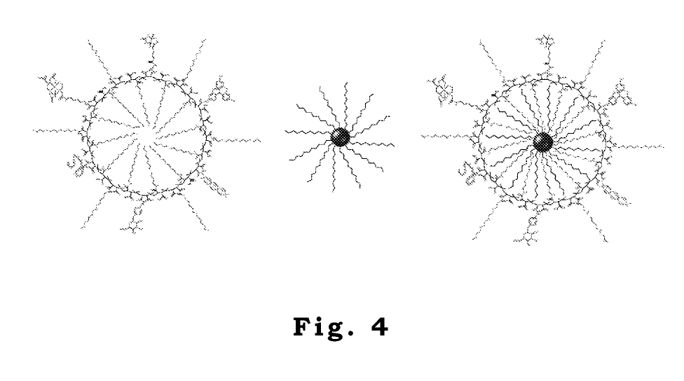

Referring to FIG. 3, the present invention discloses not only the structure and forming method of the water-soluble polymer micell but also the method for introducing a specific group to the exterior surface of the polymer micelle, such as specific chemical functional group, fluorescent molecule, magnetic molecule, biological molecule or any combination of the above. FIG. 3 is a schematic diagram illustrating some bonding of the specific group, but it does not mean that all of the groups in the figure are required to be introduced on the polymer micell according to the present invention. As shown in FIG. 4, the present invention further discloses how to form a nano/sub-nano structure having single functionality or multiple functionalities by introducing a specific chemical functional group, fluorescent molecule, magnetic molecule, biological molecule or any combination of the above to the nano/sub-nano structure via modifying a polymer shell. In the present invention, the polymer shell with the specific group is called for short “nanocoat”. As the nano/sub-nano structure wears nanocoat, the nano/sub-nano structure having single functionality or multiple functionalities is thus formed. The material of the core of the nano/sub-nano structure may be different, but the nano/sub-nano structure having the same functionality can be formed by wearing the same nanocoat.

The method for forming a composite with a nano/sub-nano core and a polymer shell is described in the following. At first, a surface with a nano/sub-nano structure is provided. The common nanomaterial comprises zero-dimensional nanomaterial (e.g. metal nanoparticle, quantum dot, magnetic nanoparticle, nano-oxide, etc.) and one-dimensional nanomaterial (e.g. nano wire, nanocarbon tube, etc.). Next, a blending process in an anhydrous solvent is carried out to mix a water-soluble polymer micell with a nano/sub-nano structure. Thus, the hydrophobic side chain of the core of the polymer micell attracts and wraps the nano/sub-nano structure so as to form the composite with a nano/sub-nano core and a polymer shell. The blending process may comprise a heating process and the temperature range of the heating process is more than or equal to 40° C. Therefore, sufficient energy is provided to promote the motion of polymer chains so as to enhance the coating effect. After the composite with a nano/sub-nano core and a polymer shell is formed, a solvent removal process is carried out to obtain a solid-state composite. Furthermore, a crosslinking process by a crosslinking agent is carried out to the composite. Preferably, the crosslinking agent is used to react with the residual anhydride group in the composite.

Similarly, this embodiment also discloses how to form a composite with a hydrophobic material core and a polymer shell by attracting and coating a hydrophobic material via the hydrophobic side chain of the core of the polymer micell. At first, at least one hydrophobic material, comprising lipid-soluble drug or molecule, is provided. Next, a blending process in an anhydrous solvent is carried out to mix a water-soluble polymer micell with the hydrophobic material. Thus, the hydrophobic side chain of the core of the polymer micell attracts and wraps the at least one hydrophobic material so as to form the composite with a hydrophobic material core and a polymer shell. The blending process may comprise a heating process and the temperature range of the heating process is more than or equal to 40° C. Therefore, sufficient energy is provided to promote the motion of polymer chains so as to enhance the coating effect. After the composite with a hydrophobic material core and a polymer shell is formed, a solvent removal process is carried out to obtain a solid-state composite. Furthermore, a crosslinking process by a crosslinking agent is carried out to the composite. Preferably, the crosslinking agent is used to react with the residual anhydride group.

### EXAMPLE 6 FORMING A COMPOSITE WITH A QUANTUM DOT CORE AND A DYE-GRAFTING POLYMER SHELL

At first, 0.5 mg of the amino dye (ATTO 590-amine, from ATTO-TEC GmbH) is dissolved in anhydrous chloroform. The concentration of the amino dye is detected by measuring the optical density at 700 nm. The extinction coefficient of ATTO 700-amine provided by the supplier is 120000 M⁻¹cm⁻¹. The concentration of the amino dye is measured to be 9.75 mM. At a room temperature, 10 ml of the amphiphilic polymer intermediate (0.8M, defined as 100% of anhydride equivalent and provided by Example 1) and 8.2 ml of the amino dye (9.75 mM, its equivalent is about 1% of anhydride equivalent.) are mixed together and violently stirred. The reaction continues and the solution is stirred overnight.

After the dye grafting amphiphilic polymer (hereinafter referred to as “polymer shell”) is synthesized, 913.5 ml of the polymer shell solution, 1 ml of anhydrous chloroform, and 50 ml of 3.3 mM (dispersed in chloroform) CdSe/ZnS quantum dots (Qdot 545 ITK organic quantum dots 1 mM solution, Invitrogen, #Q21791MP) are placed in a round bottomed flask. Then, the temperature of the mixture solution is raised to 55˜60° C. and heated for 40 seconds to promote the mobility of the polymer molecular chains so as to have better enclosing or coating effect. The mixture solution is then stirred and processed with a vacuum evaporator at the same time for 15 mins to remove the solvent (operating pressure: 200 mbar). As the solvent is completely removed, the pressure reduces to 20 mbar and dried solid powders are obtained. After the vacuum evaporation is complete, 46 ml of the 1 mM crosslinking agent, bis(hexamethylene)triamine (Fluka, #14506) (which is dissolved in anhydrous chloroform and whose equivalent is about 5% of anhydride equivalent) and the powders are mixed together and stirred for 15 mins. 1 equivalent of the crosslinking agent reacts with 2 equivalent of the anhydride group. Therefore, a total of 10% of anhydride has the crosslinking reaction. After the crosslinking reaction is complete, the solvent is removed by vacuum evaporation processing (operating pressure: 200 mbar). As the solvent is completely removed, the pressure reduces to 20 mbar and the solid product, a composite with a quantum dot core and a dye-grafting polymer shell, is obtained. In addition, the solid product can be further dissolved in an alkaline solution, such as 0.1 N NaOH or SBB pH12 adjusted by NaOH, to form a mono-dispersed nano composite particle suspended in the aqueous phase.

Fluorescence resonance energy transfer (FRET) is a distance-dependent interaction between the electronic excited states of two dye molecules in which excitation is transferred from a donor molecule to an acceptor molecule without emission of a photon. The absorption spectrum of the acceptor must overlap the emission spectrum of the donor. Additionally, the efficiency of FRET is dependent on the inverse sixth power of the intermolecular separation. Donor and acceptor molecules must be in close proximity (typically 10-100 Å). Thus, FRET is an important technique for investigating a variety of biological phenomena that produce changes in molecular proximity.

The above-mentioned composite with quantum dot core and dye-grafting polymer shell in Example 6 can be used as FRET-based nanosensors, wherein by embedding the acceptor dye directly in the amphiphilic polymer can make the donor nanoparticle water soluble leads to a novel and advantageous geometry. This assembly is known to provide an excellent colloidal stability and it allows for all post-modification steps.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A amphiphilic polymer, comprising:
a polymer backbone derived from a homopolymer or copolymer of an anhydride, and the molecular weight of the homopolymer or copolymer of anhydride is more than or equal to 1000;
at least one hydrophobic side chain, wherein one end of the hydrophobic side chain is bound to the polymer backbone; and
at least one hydrophilic side chain, wherein one end of the hydrophilic side chain is bound to the polymer backbone.

2. The polymer according to claim 1, wherein the homopolymer or copolymer of the anhydride comprises one selected from a group consisting of the following: poly(maleic anhydride), poly(isobutylene-alt-maleic andydride), Poly(maleic anhydride-alt-1-octadecene), Poly(maleic anhydride-alt-1-tetradecene), Poly(ethylene-alt-maleic anhydride), Polyethylene-graft-maleic anhydride, Polyisoprene-graft-maleic anhydride, Polypropylene-graft-maleic anhydride, Poly(styrene-co-maleic anhydride), Poly(methyl vinyl ether-alt-maleic anhydride).

3. The polymer according to claim 1, wherein the hydrophobic side chain is formed by hydration of a hydrophobic molecule and the homopolymer or copolymer of the anhydride, and the hydrophobic molecule comprises a first group to have hydration reaction with the anhydride.

4. The polymer according to claim 3, wherein the first group comprises one selected from a group consisting of the following: amino group, hydroxyl group, and thiol group.

5. The polymer according to claim 3, wherein the hydrophobic molecule further comprises a spacer, and the spacer is bound with the first group.

6. The polymer according to claim 5, wherein the spacer comprises oligomers or polymers.

7. The polymer according to claim 3, wherein the hydrophobic molecule further comprises a spacer having the first group therein.

8. The polymer according to claim 7, wherein the spacer comprises one selected from a group consisting of the following:
fluorescent molecule, magnetic molecule, and drug.

9. The polymer according to claim 1, wherein the hydrophilic side chain is formed by hydration of a hydrophilic molecule and the homopolymer or copolymer of the anhydride, and the hydrophilic molecule comprises a second group to have hydration reaction with the anhydride.

10. The polymer according to claim 9, wherein the second group comprises one selected from a group consisting of the following: amino group, hydroxyl group, and thiol group.

11. The polymer according to claim 9, wherein the hydrophilic molecule further comprises a spacer, the spacer is bound with the second group and also bound with a specific group.

12. The polymer according to claim 11, wherein the spacer comprises oligomers or polymers.

13. The polymer according to claim 11, wherein the specific group comprises one selected from a group consisting of the following: amino group, thiol group, fluorescent molecule, magnetic molecule, and biological molecule.

14. The polymer according to claim 9, wherein the hydrophilic molecule further comprises a spacer, the spacer is bound with the second group and having a specific group therein.

15. The polymer according to claim 14, wherein the spacer comprises one selected from a group consisting of the following: fluorescent molecule, magnetic molecule, and biological molecule.

16. The polymer according to claim 9, wherein the hydrophilic molecule further comprises a space having the second group and a specific group therein.

17. The polymer according to claim 16, wherein the spacer comprises one selected from a group consisting of the following: fluorescent molecule, magnetic molecule, and biological molecule.

18. The polymer according to claim 1, wherein the amphiphilic polymer is utilized in hydrophilic surface modification or hydrophobic surface modification.

19. The polymer utilized in hydrophilic surface modification according to claim 18, wherein the method for hydrophilic surface modification comprises:
providing a substrate with a hydrophobic surface;
dispersing the amphiphilic polymer in an anhydrous solvent to form a modification solution; and
performing a contact process to have the modification solution and the substrate contact with each other, and thus to have the hydrophobic side chain of the amphiphilic polymer attract and wrap the substrate to form a modified layer on the surface of the substrate, so as to introduce the hydrophilic side chain on the surface of the substrate.

20. The polymer according to claim 19, wherein the contact process comprises a heating process and the temperature range of the heating process is more than or equal to 40° C.

21. The polymer according to claim 19, wherein a solvent removal process is carried out after the modified layer is formed, so as to obtain a solid-state modified layer.

22. The polymer according to claim 19, wherein a crosslinking process by a crosslinking agent for the modified layer is carried out after the modified layer is formed.

23. The polymer according to claim 22, wherein the crosslinking agent is used to react with the residual anhydride group in the modified layer.

24. The polymer utilized in hydrophobic surface modification according to claim 18, wherein the method for hydrophobic surface modification comprises:
providing a substrate with a hydrophilic surface;
dispersing the amphiphilic polymer in an anhydrous solvent to form a modification solution; and
performing a contact process to have the modification solution and the substrate contact with each other, and thus to have the hydrophilic side chain of the amphiphilic polymer attract and wrap the substrate to form a modified layer on the surface of the substrate, so as to introduce the hydrophobic side chain on the surface of the substrate.

25. The polymer according to claim 24, wherein the contact process comprises a heating process and the temperature range of the heating process is more than or equal to 40° C.

26. The polymer according to claim 24, wherein a solvent removal process is carried out after the modified layer is formed, so as to obtain a solid-state modified layer.

27. The polymer according to claim 24, wherein a crosslinking process by a crosslinking agent for the modified layer is carried out after the modified layer is formed.

28. The polymer according to claim 27, wherein the crosslinking agent is used to react with the residual anhydride group in the modified layer.

29. A water-soluble polymer micelle formed from the amphiphilic polymer in claim 1, and the water-soluble polymer micell comprising:
a polymer backbone derived from a homopolymer or copolymer of an anhydride;
at least one hydrophobic side chain, wherein one end of the hydrophobic side chain is bound to the polymer backbone, and the hydrophobic side chain attracts to each other and aggregates inwardly so as to form a core of the polymer micell; and
at least one hydrophilic side chain, wherein one end of the hydrophilic side chain is bound to the polymer backbone and the hydrophilic side chain forms a shell of the polymer micell so as to disperse and stabilize the polymer micell in aqueous solution.

30. The micell according to claim 29, wherein the hydrophobic side chain of the core of the polymer micell attracts and wraps at least one nano/sub-nano structure, so to form a composite with a nano/sub-nano core and a polymer shell.

31. The micell according to claim 30, wherein the nano/sub-nano structure is quantum dot, the hydrophilic side chain, forming the polymer shell, having or bound with fluorescent molecule, and the absorption spectrum of the fluorescent molecule overlaps the emission spectrum of the quantum dot.

32. The micell according to claim 31, wherein the composite with quantum dot core and fluorescent molecule-contained polymer shell is used as FRET-based nanosensor.

33. The micell according to claim 29, wherein the hydrophobic side chain in the inner layer of the polymer micell attracts to each other and coats at least one hydrophobic material to form a composite with a hydrophobic material core and a polymer shell.

34. The micell according to claim 33, wherein the hydrophobic material comprises a lipid-soluble drug or molecule.
